(19) United States
(12) Patent Application Publication
(10) Pub. No.: US 2014/0335304 A1
(43) Pub. Date: Nov. 13, 2014

(54) RESIN, METHOD FOR FABRICATING RESIN, AND COMPOSITION

(71) Applicant: TOYO GOSEI CO., LTD., Chiba (JP)

(72) Inventor: Takeshi Osaki, Inzai-shi (JP)

(73) Assignee: TOYO GOSEI CO., LTD., Chiba (JP)

(21) Appl. No.: 14/274,362

(22) Filed: May 9, 2014

Related U.S. Application Data
(60) Provisional application No. 61/821,537, filed on May 9, 2013.

(51) Int. Cl. C08F 220/18

(52) U.S. Cl. CPC C08F 220/18
USPC 428/98; 526/281; 522/183

(57) ABSTRACT

A resinous structure derived from fluorine-containing polymers useful as a mold with dimensional stability is disclosed.

### CROSS-REFERENCE TO RELATED APPLICATION

This application claims the benefit under 35 U.S.C. §119(e) of U.S. Provisional Patent Application Ser. No. 61/821,537, filed on May 9, 2013, the disclosure of which is hereby incorporated herein in its entirety by this reference.

### TECHNICAL FIELD

Several aspects of the present invention relates to the field of composition for forming resin and resin.

### BACKGROUND

Resins having excellent characteristics such as resistance to heat have been desired. Such resins can be suitable for optical or electronic components of devices because such resin can show suppression of deformation or dimensional change by heat generated during operation of device.

Optical materials for radically curable compositions suitable for cast molding are disclosed in JP 2004-2702A (laid-open disclosure date: Jan. 8, 2004), the contents of the entirety of which are incorporated herein by this reference.

### BRIEF SUMMARY

Resins of which changes of pattern even by heating are small and compositions for forming such resins are disclosed in certain embodiments of the present invention. Such resin can be applied to plural types of optical components such as light guide plate, polarization plate, antireflection film and lens. Such resin also can be applied to plural types of electronic elements such as transistor and diode.

A resin is disclosed in certain embodiments relating to an aspect of the present invention. It is preferred that the resin includes: a first surface where a plurality of first portions and a plurality of second portions are formed; and a second surface that opposes the first surface. It is preferred that: the plurality of first portions are positioned at a constant distance from the second surface; each of the plurality of second portions includes two first parts positioned at a first distance from the second surface and a second part positioned at a second distance from the second surface; the first distance is different from the second distance; the first distance is equal to the constant distance; the second part is positioned between the two first parts; the constant distance terminates at boundaries between the plurality of first portions and the plurality of second portions; a change in distances between the first distance and the second distance starts at each of the two first parts when traveling from each of the boundaries toward the second part; and the resin is characterized by that a ratio (Δw/w0) of a distance difference between a third distance between the two first parts at a first time prior to a heating treatment and a fourth distance between the two first parts at a second time after the heating treatment to the third distance being equal to or smaller than 7.0%.

Resin with such dimensional change by heat is a suitable for various components such as insulating film of electronic device and lens.

It is more preferred that the (Δw/w0) is equal to or smaller than 2.0%.

It is preferred that the heating treatment is carried out in such a way that the resin is heated at 373 K for two weeks.

It is preferred that the resin is adapted to function as at least a part of an optical component. Such resin with small dimensional change by heat is suitable for optical component such as waveguide and lens because change in optical path or its length can be minimized.

A method for fabricating a resin is disclosed in certain embodiments relating to an aspect of the present invention. The method includes a step of providing a mixture including a first monomer and an initiator for initiating a polymerization reaction of the first monomer. It is preferred that a molecular weight of the initiator is equal to or greater than 224. Since such initiator of which molecular weight is equal to or greater than 224 is less volatile, decrease in volume of resin is suppressed even by heating.

It is more preferred that the molecular weight of the initiator is equal to or greater than 340. Such resin shows more suppression of decrease in volume.

It is preferred that the mixture further including a second monomer.

It is preferred that the mixture further includes a third monomer.

It is preferred that the first monomer has only one polymerization group, and the second monomer having two polymerization groups.

It is preferred that: the first monomer having only one polymerization group; the second monomer has two polymerization groups; and the third monomer having three polymerization groups.

Another resin is disclosed in certain embodiments relating to an aspect of the present invention. It is preferred that such resin is characterized by that a weight difference a first weight at a first time before a heating treatment and a second weight after the heating treatment being equal to or smaller than 7.0%.

A composition is disclosed in certain embodiments relating to an aspect of the present invention. The composition includes: a first compound that has a first substituent that is polymerizable; and an initiator. It is preferred that a molecular weight of the initiator is equal to or greater than 224.

It is preferred that the molecular weight of the initiator is equal to or greater than 340.

It is preferred that the composition further includes a second compound that has a second substituent that is polymerizable and a third substituent that is polymerizable.

It is preferred that the composition further includes: a second compound that has a second substituent that is polymerizable and a third substituent that is polymerizable; and a third compound that has a fourth substituent that is polymerizable and a fifth substituent that is polymerizable.

It is preferred that the initiator includes at least two bonds of which cleavages occur by a light irradiation.

It is preferred that the initiator is characterized that an irradiation of the initiator with a light of which wavelength is equal to or greater than 370 nm.

A component is disclosed in certain embodiments relating to an aspect of the present invention. The component includes any one of the resin explained above.

### BRIEF DESCRIPTION OF THE DRAWINGS

In the drawings, which illustrate what is currently considered to be the best mode for carrying out the invention:

FIG. 1 shows the experimental procedures for observation of surface of resin.

FIG. 2 illustrates the change in width (Δw) of the resin with a surface where an angled concave-convex pattern is formed.

FIG. 3 illustrates the change in width (Δw) of the resin with a surface where a curved concave-convex pattern is formed.

### DETAILED DESCRIPTION

### Experimental Procedures:

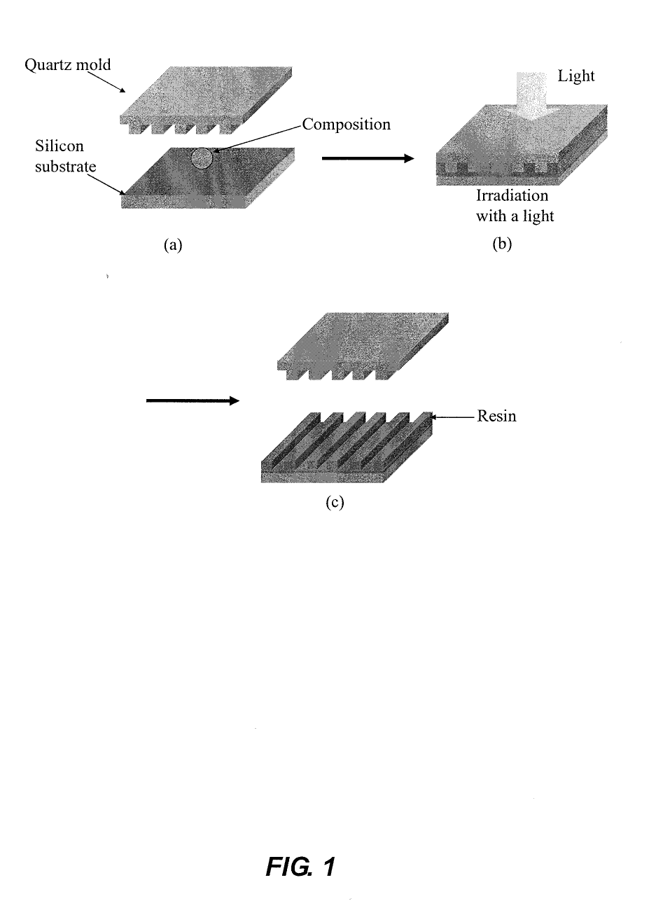

FIG. 1 shows the experimental procedures for observation of surface of resin.

The experimental procedure is as follows:

(a) A composition for forming resin is disposed on a silicon substrate.

(b) A concavo-convex surface of a quartz mold is pressed to the composition against the silicon substrate. An irradiation of the composition with a light transmitted through the quartz mold forms a resin of which surface has a concavo-convex pattern transferred from the quartz mold.

(c) The resin is released from the quartz mold.

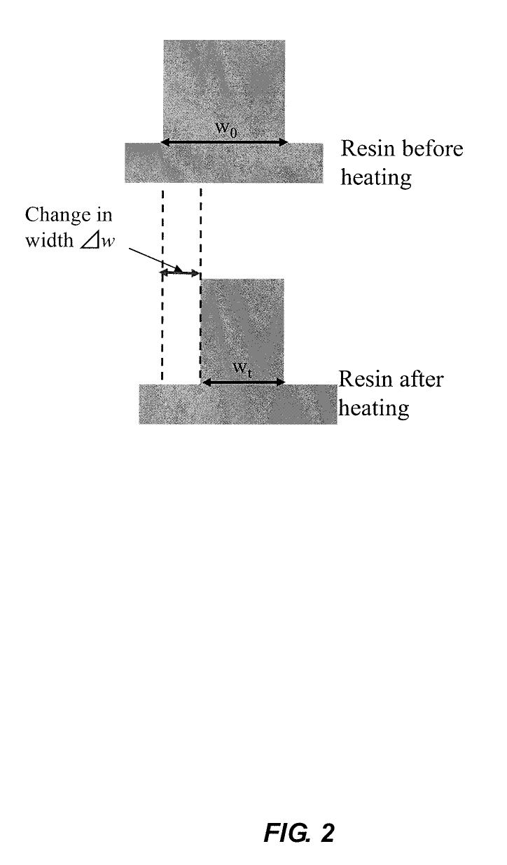

For resin used for optical components and electronic components, it is generally desirable that there is little deterioration of pattern of the resin even by heating. FIG. 2 shows an explanation for change of an angled concave-convex pattern of the resin by heating. The parameters w0, wt, and Δw are the width of the convex portion before a heat treatment, that after the heat treatment, and change from w0 to wt, respectively. The heat treatment is carried out in such a way that the resin is heated at 373 K for two weeks.

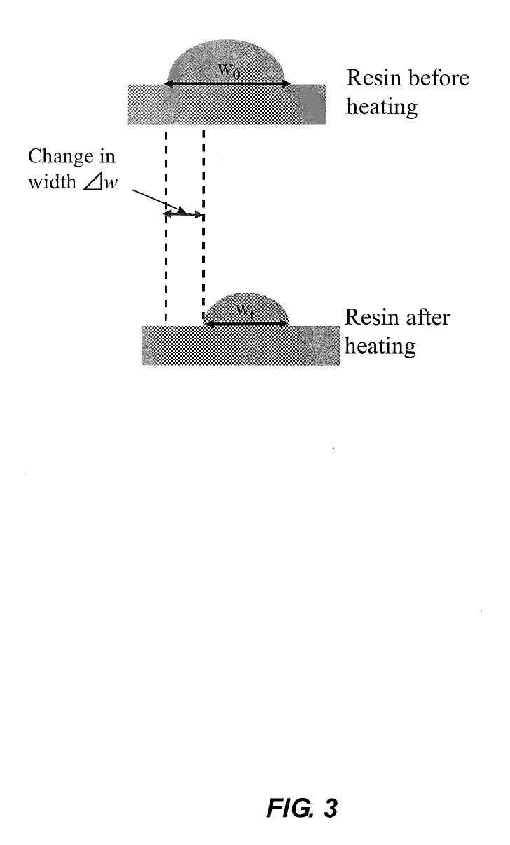

FIG. 3 shows an explanation for change of a curved concave-convex pattern of the resin by heating. The parameters w0, wt, and Δw are the width of the convex portion before a heat treatment, that after the heat treatment, and change from w0 to wt, respectively. The heat treatment is carried out in such a way that the resin is heated at 373 K for two weeks.

Table 1 shows compositions of resin, the molecular weight of initiator, a change in width of the convex portion, its ratio (Δw/w0) and a decrease rate in weight of the resin after heating. Δw/w0 and the decrease rate in weight for Entry 3 are 6.7% and 6.8%, respectively. Such low changes in the width of the convex portion and weight of the resin are desirable for components such as light guide plate, polarization plate, antireflection layer and lens. For obtaining resin having such low values for Δw and the decrease rate in weight, an initiator of which molecular weight is equal to or more than 224 is preferred.

TABLE 1
Compositions of resin, the molecular weight of initiator, a change in
width of the convex portion, its ratio, and a decrease rate in weight of the resin after heating.

| | Entry1 | Entry2 | Entry3 | Entry4 | Entry5 | Entry6 | Entry7 |
|---|---|---|---|---|---|---|---|
| Constituent A | 60 | 60 | 60 | 60 | 60 | 60 | 60 |
| Constituent B | 21 | 21 | 21 | 21 | 21 | 21 | 21 |
| Constituent C | 15 | 15 | 15 | 15 | 15 | 15 | 15 |
| Initiator I | 4 | | | | 1 | | |
| Initiator II | | 4 | | | | | |
| Initiator III | | | 2 | | | | |
| Initiator N | | | | 4 | | | |
| Initiator V | | | | | 0.5 | 4 | |
| Initiator VI | | | | | | | 4 |
| Molecular weight of initiator | 204 | 164 | 224 | 340 | — | 418 | >400 |
| [symbol] w/μm after heating at 373K | 0.22 | 0.22 | 0.20 | 0.05 | 0.06 | 0.04 | 0.06 |
| for two weeks | | | | | | | |
| [symbol] w/w₀ | 7.3% | 7.3% | 6.7% | 1.7% | 2.0% | 1.3% | 2.0% |
| Decrease rate in weight of the | 7.9% | 8.0% | 6.8% | 3.6% | 3.8% | 3.2% | 4.3% |
| resin after heating at 373K | | | | | | | |
| for two weeks | | | | | | | |

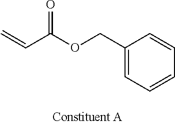

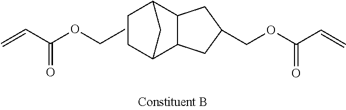

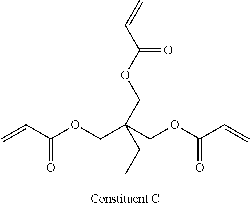 [SMILES: C=CC(=O)OCC(CC)(COC(=O)C=C)COC(=O)C=C]

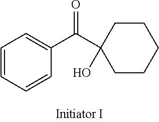 [SMILES: O=C(c1ccccc1)C1(O)CCCCC1]

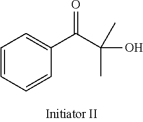

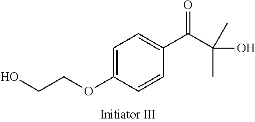 [SMILES: CC(C)(O)C(=O)c1ccc(OCCO)cc1]

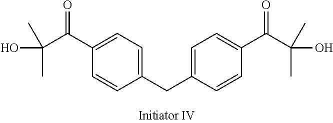 [SMILES: CC(C)(O)C(=O)c1ccc(Cc2ccc(C(=O)C(C)(C)O)cc2)cc1]

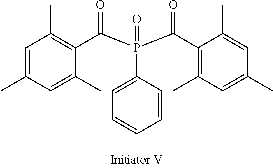

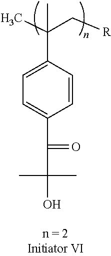

More desirable values for Δw/w0 and the decrease rate in weight are equal to or smaller than 3% and 5%, respectively. Furthermore, ideal values for Δw/w0 and the decrease rate in weight are equal to or smaller than 2.0% and 4.3%, respectively. An initiator of which molecular weight is equal to or more than 340 is preferred for obtaining resin having such ideal values. Each of compositions shown in Table 1 includes a monomer having only one polymerizable substituent. In addition to the monomer with only one polymerizable substituent, a monomer having plural polymerizable substituents is contained in each of the compositions.

### Initiators:

As an initiator, for example, acetophenone-based initiators, alkylphenone-based initiators, benzoin-based initiators, benzyl ketal-based initiators, anthraquinone-based initiators, acyloxime-based initiators, and acyl phosphine oxide-based initiators can be used for curing the precursors.

An initiator of which molecular weight is equal to or greater than 224 is desirable for fabricating a resin with thermal tolerance. An initiator of which molecular weight is equal to or greater than 340 is more desirable for fabricating such resin.

An initiator of which photoreaction occurs by an irradiation with a light of which wavelength is 370 nm is desirable for fabricating such resin. An initiator that has at least two bonds of which cleavages occur by a light irradiation is also desirable.

What is claimed is:

1. A resin, comprising:
a first surface where a plurality of first portions and a plurality of second portions are formed; and
a second surface that opposes the first surface,
the plurality of first portions being positioned at a constant distance from the second surface,
each of the plurality of second portions including two first parts positioned at a first distance from the second surface and a second part positioned at a second distance from the second surface,
the first distance being different from the second distance.
the first distance being equal to the constant distance,
the second part being positioned between the two first parts, and
the constant distance terminating at boundaries between the plurality of first portions and the plurality of second portions,
a change in distances between the first distance and the second distance starting at each of the two first parts when traveling from each of the boundaries toward the second part, and
the resin being characterized by that a ratio (Δw/w0) of a distance difference between a third distance between the two first parts at a first time prior to a heating treatment and a fourth distance between the two first parts at a second time after the heating treatment to the third distance being equal to or smaller than 7.0%.

2. The resin according to claim 1, the (Δw/w0) being equal to or smaller than 2.0%.

3. The resin according to claim 1, the heating treatment being carried out in such a way that the resin is heated at 373 K for two weeks.

4. The resin according to claim 1, the resin being adapted to function as at least a part of an optical component.

5. A method for fabricating a resin, comprising:
providing a mixture including a first monomer and an initiator for initiating a polymerization reaction of the first monomer,
a molecular weight of the initiator being equal to or greater than 224.

6. The method according to claim 5, the molecular weight being of the initiator being equal to or greater than 340.

7. The method according to claim 5, the mixture further including a second monomer.

8. The method according to claim 7, the mixture further including a third monomer.

9. The method according to claim 7, the first monomer having only one polymerization group, and the second monomer having two polymerization groups.

10. The method according to claim 8, the first monomer having only one polymerization group, the second monomer having two polymerization groups, and the third monomer having three polymerization groups.

11. A resin, the resin being characterized by that a weight difference a first weight at a first time before a heating treatment and a second weight after the heating treatment being equal to or smaller than 7.0%.

12. A composition, comprising:
a first compound that has a first substituent that is polymerizable; and
an initiator,
a molecular weight of the initiator being equal to or greater than 224.

13. The composition according to claim 12, the molecular weight of the initiator being equal to or greater than 340.

14. The composition according to claim 12, further comprising:
a second compound that has a second substituent that is polymerizable and a third substituent that is polymerizable.

15. The composition according to claim 12, further comprising:
a second compound that has a second substituent that is polymerizable and a third substituent that is polymerizable; and
a third compound that has a fourth substituent that is polymerizable and a fifth substituent that is polymerizable.

16. The composition according to claim 12, the initiator including at least two bonds of which cleavages occur by a light irradiation.

17. The composition according to claim 12, the initiator being characterized that an irradiation of the initiator with a light of which wavelength is equal to or greater than 370 nm.

18. A component, comprising:
the resin according to claim 1.

19. A component, comprising:
the resin according to claim 11.
